(19) United States
(12) Patent Application Publication
(10) Pub. No.: US 2007/0003024 A1
(43) Pub. Date: Jan. 4, 2007

(54) Network emergency call taking system and method

(75) Inventors: Pierre Olivier, Gatineau (CA); Douglas Gordon Roberts, Richmond (CA)

Correspondence Address: BUCHANAN, INGERSOLL & ROONEY PC, POST OFFICE BOX 1404, ALEXANDRIA, VA, 22313-1404, US

(73) Assignee: CML EMERGENCY SERVICES INC., Gatineau (CA)

(21) Appl. No.: 11/157,913

(22) Filed: Jun. 22, 2005

(51) Int. Cl. H04M 11/04; H04L 12/28

(52) U.S. Cl. 379/45; 370/351

(57) ABSTRACT

The present invention provides a system and method for routing voice and non-voice communications to an answering point via a packet network. Incoming communications from a communication network are converted into packet signals suitable for the packet network. An answering point and a workstation in the answering point are selected. The call is routed to the selected answering point and workstation over the packet network.

### FIELD OF THE INVENTION

The present invention relates to a call taking system and method for providing call taking service for a plurality of communication networks.

### BACKGROUND

Emergency call-taking systems are typically made up of two components: a network component, responsible for delivering calls to the appropriate call center or Public Safety Answering Point (PSAP), and a Customer Premises Equipment (CPE) component, responsible for call distribution within the PSAP. These two elements are typically connected with trunks known as Centralized Automated Message Accounting (CAMA) trunks. Calls from the network component are routed to an appropriate PSAP on a dedicated trunk by a switch, such as a tandem switch.

There has been interest in the use of Voice over Internet Protocol (VoIP) techniques to replace the CAMA trunk infrastructure. Various proposals have been made, which share a common theme involving the centralization of the network and PSAP components in one monolithic system combining both functionalities.

Although potentially simple and cost-effective, these solutions do not address the realities of the emergency call-taking market, where the network component is typically owned and operated by a telephone service provider, whereas the CPE component is typically owned and operated by the call center. Furthermore, the CPE component is expected to provide additional functionality such as administrative (non-emergency) call processing, not effectively offered by a monolithic solution.

In conventional emergency call taking systems, the existing network component, for example a 911 Tandem, typically has limited flexibility and may have limited ability to handle 911 calls that originate from different network types, such as IP, wireless etc. In the conventional systems, circuit trunks for wireless, and TDM (Time Division Multiplexing) telephony are switched in the 911 Tandem. Incoming IP telephone calls are converted to normal telephone signal formats. IP telephony calls have to be converted to TDM before reaching the tandem switch. As well, the tandem switch typically implements only time of arrival queuing with an overflow procedure to be implemented on receipt of an “all operators busy” signal.

### SUMMARY OF THE INVENTION

The system and method described here take a modular approach, where the network component and the CPE component are separate subsystems. This approach allows both distributed and centralized deployment models. At the same time, the system and method make use of packet protocol techniques to interconnect the subsystems.

The new system can be thought of as a “transaction centric” model in which communications of all types are processed together, with no distinction needing to be made between a non-voice communication, such as an SMS originated call, for example, and a voice communication such as a wireless call.

Embodiments of the system and method described here enable interconnection of a VoIP telephony service provider to an emergency call-taking network system using VoIP techniques.

Embodiments of the present invention provide a system and method for providing emergency telephone call taking capability using a packet network, operator workstations, telephone circuit gateways, and call management servers.

In one aspect, there is provided a call taking system for providing call taking service for a plurality of communication networks, the call taking system comprising: a packet network; a plurality of answering points; and at least one data center configured to: a) receive incoming communications from the plurality of communication networks; and b) for each incoming communication, select an answering point from the plurality of answering points to handle the incoming communication and send the incoming communication to the answering point selected via the packet network.

In a second aspect, there is provided a data center for routing communications from a plurality of communication networks to a plurality on answering points, the data center comprising: a gateway for interfacing with the communication networks, the gateway configured to receive incoming communications and to convert non-packet incoming communications to packet signals; a packet interface for interfacing with a packet network, the packet interface configured to send and receive packet signals to and from a plurality of answering points via the packet network; and a server configured in such a manner that for each incoming communication the server: selects one of the plurality of answering points to handle the incoming communication; and instructs the packet interface to send the incoming communication to the answering point selected.

In a third aspect, there is provided a method of routing communications from a plurality of communication networks to one of a plurality of answering points, the method comprising: receiving an incoming communication from any one of the communication networks; selecting one of the answering points to handle the incoming communication; sending the incoming communication to the answering point selected via a packet network.

In a fourth aspect, there is provided a call-taking system for providing emergency call taking for a plurality of communications networks, the system comprising: a plurality of PSAP call centres; a packet network interconnecting the plurality of communications networks and the plurality of PSAP call centres, the packet network comprising at least one packet network proxy server; each PSAP call centre comprising a PSAP call center network, a plurality of PSAP workstations and a PSAP proxy server; wherein each call setup request received by the packet network proxy server from one of the communications networks contains location information; wherein for each call set up request the packet network proxy server uses the location information to select a PSAP call centre of the plurality of PSAP call centres and forwards the call setup request to the PSAP proxy server of the selected PSAP call centre; wherein each PSAP proxy server is responsible for selecting a particular one of the PSAP workstations to handle each call setup request received by the PSAP proxy server; wherein after selection of the particular PSAP workstation to handle the call setup request, a connection is established from between a calling device or an agent of the calling device to the selected PSAP call center via the network.

In a fifth aspect, there is provided a call-taking system for providing emergency call taking for a plurality of communications networks, the system comprising: a plurality of PSAP call centres; a wide area packet network having circuit switched connections to the plurality of communications networks and connected to the plurality of PSAP call centres, the packet network comprising a selective router and at least one VoIP gateway; at least one VoIP PSAP call centre comprising a PSAP call center packet network, a plurality of PSAP workstations and a PSAP proxy server; wherein each call received at the selective router from one of the communications network contains an Emergency Services Routing Key (ESRK) or, in the case of a wireline call, ANI (Automatic Number Identification); the selective router uses the ESRK or ANI to select a VoIP gateway to handle each call, the selected VoIP gateway sending a call setup request to a proxy server in a PSAP call centre; wherein each PSAP proxy server is responsible for selecting a particular one of the PSAP workstations to handle each call setup request received by the PSAP proxy server; wherein after selection of the particular PSAP workstation to handle the call set up request, a VoIP connection is established from between the gateway and the selected PSAP call centre via the network.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying drawings, in which:

FIG. 1 is a block diagram of a call taking system in accordance with an embodiment of the present invention;

FIG. 2 is a block diagram of an exemplary data center in accordance with an embodiment of the present invention;

FIG. 3 is a block diagram of an exemplary emergency call taking system in accordance with an embodiment of the present invention;

FIG. 4A is a flowchart of a method for selecting an answering point to take a call in accordance with an embodiment of the present invention;

FIG. 4B is a flowchart of a method of receiving communications from a plurality of communication networks in accordance with an embodiment of the present invention;

FIG. 4C is a flowchart of a method of selecting and forwarding communications from a plurality of networks to an answering point in accordance with an embodiment of the present invention;

FIG. 4D is a flowchart of a method for selecting a workstation within an answering point to take a call in accordance with an embodiment of the present invention;

FIG. 5 is a block diagram of an exemplary data center in accordance with an embodiment of the present invention;

FIG. 6 is a block diagram an exemplary PSAP in accordance with an embodiment of the present invention;

FIG. 7 is a block diagram of another exemplary call talking system in accordance with an embodiment of the present invention;

FIG. 8 is a block diagram of another exemplary call talking system in accordance with an embodiment of the present invention;

FIG. 9 is a block diagram of an example audio management module in a workstation in accordance with an embodiment of the present invention;

FIG. 10 is a block diagram of a call taking system according to an embodiment of the present invention;

FIG. 11 is a diagram of a call taking system having multiple proxies according to an embodiment of the present invention;

FIG. 12 is an illustration of an embodiment of the present invention in which the proxies form a hierarchy; and

FIG. 13 is a block diagram of a call taking system according to an embodiment of the present invention.

### DETAILED DESCRIPTION OF THE PREFERRED EMBODIMENTS

As call taking systems have evolved, it has typically taken a “bottom up” approach, with IP being introduced for connectivity from PSAP automatic call distributing (ACD) functions to call taking workstations first. However, the connection from the 911 Tandem to the PSAP ACD is still using dedicated circuit switched trunks.

Communications usage has evolved from a point where all 911 calls were telephony calls, and all were voice, to where we are today with less than 50% of all 911 traffic being wireline voice and the remainder is mostly wireless voice. Use of VoIP and non-voice calls is rapidly increasing.

Current PSAP designs do not accommodate e-mail or SMS (Short Message Service) communications. Individual PSAP operators may have e-mail addresses, but such communications cannot be processed in a systematic way with the rest of the 911 traffic. The result is that such communications may not receive the priority they deserve, or they may receive extra priority that is not warranted.

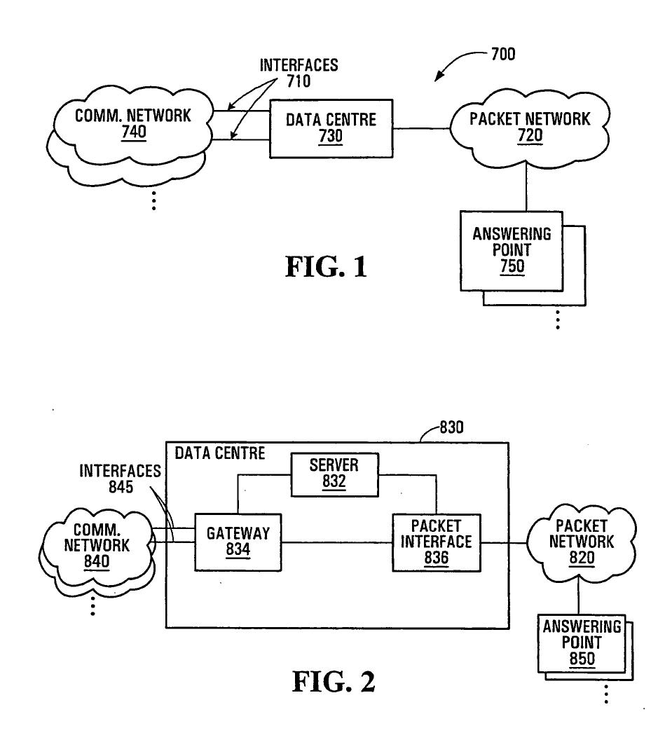

FIG. 1 is a block diagram of a call taking system 700 in accordance with an embodiment of the present invention. The call taking system 700 includes a data center 730, which is in communication with a plurality of communication networks 740 via interfaces 710. Examples of communication networks 740 include but are not limited to: circuit-based Public Switched Telephone Networks (PSTNs); wireless telephony networks such as cellular networks; packet-based IP telephone networks; and adjacent emergency call-taking networks. The data center is also in communication with a plurality of answering points 750 via a packet network 720. The answering points 750 are for taking calls from the communication networks 740 that are directed through the data center 730. Preferably, the answering points 750 are Public Safety Answering Points (PSAP), such as 911 call centers. Other examples of answering points include a taxi dispatch site, a police dispatch center, an ambulance dispatch center, a fire department dispatch center, and a call center for receiving customer calls and directing them to the proper department. The packet network 720 is any network that allows communication using packets. Examples are IP (Internet Protocol) networks, WANs (Wide Area Networks), ATM (Asynchronous Transfer Mode) networks, and Frame Relay networks.

The data center 730 can be software, hardware or combinations thereof, as required to achieve the functions described herein.

The system of FIG. 1 shows only one data center. In other embodiments, any number of data centers may exist. FIG. 1 also shows only one packet network. Multiple packet networks are possible. As well, the data center may be in direct communication with one or more answering points rather than communicating via the packet network. In those cases, the answering points in direct communication with the data center can be circuit-based.

In operation, specific calls from the communication networks 740 are routed to the data center 730. For example, in an emergency call taking system, telephone networks are configured to route 911 telephone calls to the data center. In some embodiments, when the calls are received at the data center, they are placed in a queue. The calls within the queue are prioritized according to a characteristic of the call in some embodiments. The data center converts the calls into packet signals, if they are not already in packet form. The data center also selects an answering point 750 to take each call using a method described below and sends the converted call to the selected answering point 750 via the packet network 720.

By converting calls to packet signals at the data center and sending the packet signals to answering points over the packet network, dedicated trunks are not needed between the data center and the answering points. As well, the ability to process e-mail, SMS messages, telematics and Instant Messaging at the data center is enabled. In some embodiments, the communication network is programmed to send e-mail and SMS messages addressed to one or more specific address to the data center. For example, in one embodiment of an emergency call taking system, e-mail messages to mailto:sos@sos.arpa or mailto:sos@switchita.ks.us.sos.arpa are sent to the data center by a public IP network, such as the internet. The data center selects an answering point to receive each message and forwards the messages to the selected answering point through the packet network in the same manner as converted calls.

Preferably, all incoming communications, be they voice, voice over IP, wireless, SMS, e-mail, telematics or Instant Messaging to name a few specific examples are handled on a per-transaction basis. Incoming communications can be handled: in the order of their arrival (regardless of communication channel); or in order of arrival, subject to prioritization. By handling all of the channels in this manner, a fair priority can be given to each call. In addition, when selecting a PSAP to handle a call, preferably load balancing across all communication channel types is performed. In other words, an operator who has just been forwarded an e-mail will be considered “busy” in the same sense as an operator who has just been forwarded a voice call.

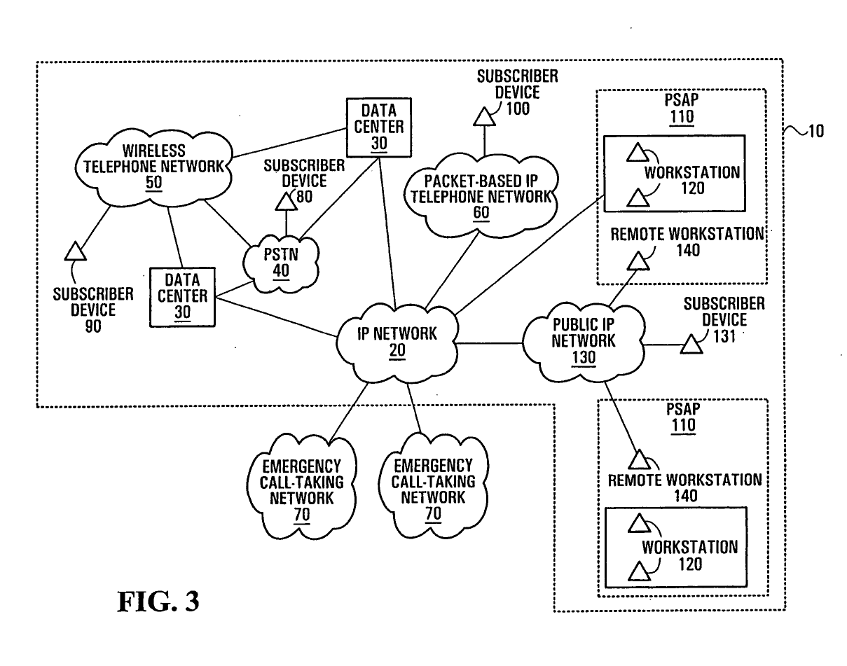

FIG. 2 is a block diagram of a data center 830 in accordance with an embodiment of the present invention. The data center includes a gateway 834 for interfacing with communication networks 840 via trunks 845, a packet interface 836 for communicating over a packet network 820, and a server 832. The server 832 is configured to select an answering point 850 out of a plurality of answering points connected to the packet network 820 to take calls received at the gateway 834 from the communication networks 840. The gateway 834 is configured to send and receive calls to and from the communication networks 840 and to convert the calls to and from packet signals. The packet interface 836 sends and receives packet signals over the packet network. For each call received, the packet interface 836 sends the call converted to packet signals to the answering point 850 selected by the server 832. In some embodiments, the data center has one gateway with enough channel capacity to handle all incoming circuits. In other embodiments, multiple gateways with smaller capacity are used.

The data center 830 can be software, hardware or any combination thereof as required to achieve the functions described above. The components of the data center 830 can be interconnected by physical circuits or by virtual connections. In some embodiments the components are functions of a software package. In the FIG. 2 example, the components of the data center 830 are collocated. However, other configurations are possible. In some embodiments, the server 832 is in a remote location. As well, the gateway 834 and the packet interface 836 can be in separate modules or they can be collocated in one module.

Emergency Call Taking System

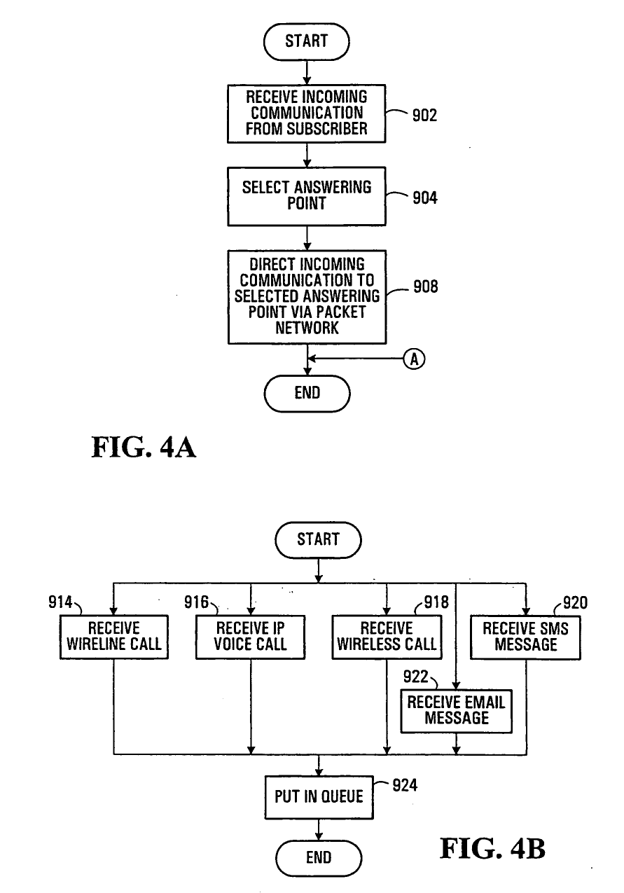

FIG. 3 is block diagram of an exemplary emergency call taking system 10 in accordance with an embodiment of the present invention. The emergency call taking system 10 comprises at least one data center 30, with two shown in the example. The data centers 30 are in communication with a wide-area IP network 20 and route emergency calls to Public Safety Answering Points (PSAPs) 110 through the IP network 20. Examples of wide-area IP networks are ATM and Frame Relay networks.

The system provides emergency call taking for a plurality of networks. In the illustrative example, these are circuit-based Public Switched Telephone Network (PSTN) 40, wireless telephony network 50 (e.g. cellular network), and packet-based IP telephone network 60. In another embodiment an SS7 system is also supported. Each of the communication networks is in communication with at least one data center 30. The packet-based IP telephone network 60 communicates with the data center 30 through the IP network 20. In some embodiments, each network is configured to direct emergency calls to a data center 30. For example, the PSTN 40 could be configured to direct all telephone calls to the phone number 911 to one of the data centers 30. In another embodiment, SMS (Short Message Service) messages on the packet-based IP telephone network 60 or the wireless telephone network 50 to one or more emergency address are directed to a data center 30. In other embodiments, e-mail messages to one or more emergency addresses are received by a data center over the IP network 20 and routed to one of the PSAPs 110. In some jurisdictions, the communication networks are mandated to direct emergency communications to the data centers.

Users of the networks include at least one wireline telephony subscriber device 80 for the PSTN, at least one wireless telephony subscriber device 90 for the wireless telephone network 50, and at least one IP telephony subscriber device 100 for the packet-based IP network 60.

The data center 30 directs calls to PSAPs 110. The PSAPs 110 include non-remote call-taker workstations 120 connected to the IP network 20, and remote call-taker workstations 140 connected to the IP network 20 via a public IP network 130, such as the Internet. Remote workstations 140 are within the PSAPs 110 for illustrative purposes only. They may be supported by the PSAPs 110 but may be remote from the PSAPs 110. The remote workstations 140 are in communication with the Public IP network 130.

In the FIG. 3 example, two adjacent emergency call-taking networks 70 are also in communication with the data center 30 via the IP network 20. The adjacent emergency call taking networks 70 may have a similar form to that of the emergency call taking system 10. They may be some combination of data centers, communication networks, packet networks and answering points.

FIG. 3 shows a specific example of an emergency call taking system. It is an example only and other combinations are possible. For example, although two data centers 30 are shown, any number of data centers 30 is possible. Likewise, although only two PSAPs are shown, any number of PSAPs is possible. As well, the data center(s) can be connected to any combination of different types and number of communication networks.

In the FIG. 3 example, the wireless telephone network 50 and PSTN 40 are in communication with both data centers 30. In some embodiments the wireless telephone network 50 and PSTN 40 are in communication with only one data center. In other embodiments the wireless communication network 50 and PSTN 40 are in communication with more than two data centers. Each communication network is shown in communication with one subscriber device, ie. wireless telephony subscriber device 90 for the wireless telephone network 50, wireline telephony subscriber device 80 for the PSTN 40, and IP telephony subscriber device 100 for the packet-based IP telephone network 60. Any number of subscriber devices are possible on each communication network.

The PSAPs 110 of the FIG. 3 example have both non-remote workstations 120 and remote workstations 130. In some embodiments, the PSAPs 110 only have non-remote workstations 120. In some embodiments, only remote workstations 140 are used.

Wireline Telephony Subscriber Call

In the FIG. 3 system, a wireline telephony subscriber device 80 can initiate an emergency call (e.g. 911 call). Such a call is routed through the PSTN 40 to one of the data centers 30, using physical circuits. The PSTN 40 is configured to forward emergency calls to a data center 30. Preferably, each individual call is routed to one data center. If both call centers are operational, load sharing techniques are used to select one of the two data centers to take a particular call. If one data center or link is down, then all calls are sent to the operational data center. The selected data center 30 determines the proper PSAP 110 to which to present the call. Preferably, such determination is based on the geographical location of the wireline telephony subscriber device 80 obtained from the PSTN 40, using a method to be described in detail later. In some embodiments the data center 30 also selects which workstation 120 or 140 will take the call. In other embodiments the selected PSAP determines which workstation 120 or 140 will take the call. The workstation 120 or 140 can then be used to answer the call, which is sent from the data center 30 to the PSAP 110 as IP packets over the IP network 20. Subsequently, the call can be transferred to any other workstation 120 or 140, any wireline telephony subscriber device 80 via the PSTN 40, any wireless telephony subscriber device 90 via the PSTN 40 and the wireless telephone network 50 or directly via the wireless telephone network 50, any IP telephony subscriber device 100 via the packet-based IP telephony network 60, or any adjacent emergency call-taking network 70. Transfers are done by either the data center server or the PSAP server. For example, the transfer between workstations is done by the PSAP server and the transfer to other subscribers is done by the data center server.

Wireless Telephony Subscriber Call

A wireless telephony subscriber device 90 can initiate an emergency call (e.g. 911 call). Such a call is routed through the wireless telephone network 50 to one of the data centers 30, using physical circuits, as described above with reference to the wireline telephony subscriber device 80. The wireless telephone network 50 is configured to forward emergency calls to a data center. The data center 30 determines the proper PSAP 110 to which to present the call. Such determination is based on an approximation of the geographical location of the wireline telephony subscriber device 80 obtained from the wireless telephone network 50, using a method to be described in detail later. A workstation 120 or 140 is also selected by either the data center 30 or the PSAP 110, as described in the wireline telephony subscriber call example. The workstation 120 or 140 can then be used to answer the call, which is sent from the data center 30 to the PSAP 110 as IP packets over the IP network 20. Subsequently, the call can be transferred to any other workstation 120 or 140, any wireline telephony subscriber device 80 via the PSTN 40, any wireless telephony subscriber device 90 via the PSTN 40 and the wireless telephone network 50 or directly via the wireless telephone network 50, any IP telephony subscriber device 100 via the packet-based IP telephony network 60, or any adjacent emergency call-taking network 70.

IP Telephony Subscriber Call

An IP telephony subscriber device 100 can initiate an emergency call (e.g. 911 call). Such a call is routed through the packet-based IP telephone network 60 to a data center 30, using virtual circuits established via the IP network 20. The packet-based IP telephone network 60 is configured to forward emergency calls to a data center 30. The data center 30 determines the proper PSAP 110 to which to present the call. Such determination is based on an approximation of the geographical location of the subscriber device 100 obtained from the packet-based IP telephone network 60, using a method to be described in detail later. A workstation 120 or 140 is selected by either the PSAP 110 or the data center 30, as described in the wireline telephony subscriber call example. The workstation 120 or 140 can then be used to answer the call, which is sent from the data center 30 to the PSAP 110 as IP packets over the IP network 20. Subsequently, the call can be transferred to any other workstation 120 or 140, any wireline telephony subscriber device 80 via the PSTN 40, any wireless telephony subscriber device 90 via the PSTN 40 and the wireless telephone network 50 or directly via the wireless telephone network 50, any IP telephony subscriber device 100 via the packet-based IP telephony network 60, or any adjacent emergency call-taking network 70.

SMS Message

An IP telephony subscriber device 100 can initiate an emergency SMS message. The SMS message is routed through the packet-based IP telephone network 60 to a data center 30, using virtual circuits established via the IP network 20. The packet-based IP telephone network 60 is configured to forward emergency SMS messages to a data center 30. The data center 30 determines the proper PSAP 110 to which to present the message, in a manner similar to that used to determine the proper PSAP in the IP telephony subscriber call example. A workstation 120 or 140 is selected by either the PSAP 110 or the data center 30, as described in the wireline telephony subscriber call example. The workstation 120 or 140 can then be used to respond to the SMS message, which is sent from the data center 30 to the PSAP 110 as IP packets over the IP network 20. Subsequently, the SMS message can be transferred to any other workstation 120 or 140 or any IP telephony subscriber device 100 via the packet-based IP telephony network 60. As well, an operator handling the SMS message can conference in any other workstation 120 or 140, any wireline telephony subscriber device 80 via the PSTN 40, any wireless telephony subscriber device 90 via the PSTN 40 and the wireless telephone network 50 or directly via the wireless telephone network 50, any IP telephony subscriber device 100 via the packet-based IP telephony network 60, or any adjacent emergency call-taking network 70.

E-mail Example

A public IP subscriber device 131 can initiate an emergency e-mail message. The e-mail message is routed through the public IP network 130 to a data center 30, using virtual circuits established via the IP network 20. The public IP network 130 is configured to forward emergency e-mail messages to a data center 30. The data center 30 determines the proper PSAP 110 to which to present the message, in a manner similar to that used to determine the proper PSAP in the IP telephony subscriber call example. A workstation 120 or 140 is selected by either the PSAP 110 or the data center 30, as described in the wireline telephony subscriber call example. The workstation 120 or 140 can then be used to respond to the e-mail message, which is sent from the data center 30 to the PSAP 110 as IP packets over the IP network 20. Subsequently, the e-mail message can be transferred to any other workstation 120 or 140, any public IP subscriber 131, or any adjacent emergency call-taking network 70. In addition, as with SMS, a voice subscriber could be conferenced in by the call-taker handling the e-mail. In some embodiments, text to speech services could be used to perform a transfer to a wireless or wireline telephony subscriber.

PSAP Selection

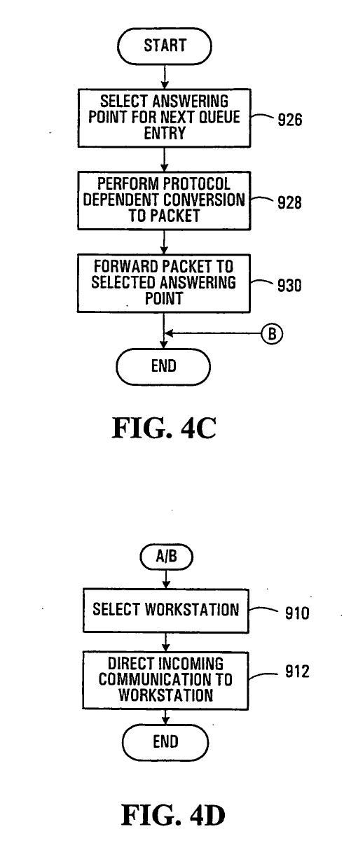

FIG. 4A is a flowchart of a method according to an embodiment of the present invention for selecting an answering point to handle an incoming communication. The incoming communication may be but is not limited to a wireline voice call, a Voice over IP call, a wireless voice call, a SMS message or an e-mail message. An incoming communication is first received from a subscriber device via a communication network (Step 902). Then an answering point is selected to handle the incoming communication (Step 904). Preferably, the answering point is selected based on the geographic location of the subscriber device. Examples of methods used to determine the geographic location of the subscriber device are discussed below. Other criteria for the selection of an answering point include the availability of the answering point and the priority of the incoming communication. The call is then directed to the selected answering point (Step 908). In preferred embodiments, the answering point selection is done at a data center, such as the one described with reference to FIG. 2.

Preferably, if the incoming communication is not in a format compatible for transmission over a packet network, the incoming communication is converted from the protocol of the incoming communication to packets for transmission over a packet network to which the answering points are connected. In some embodiments, not all answering points are connected to a packet network. Some circuit-based answering points may be directly connected to respective data centers. In those embodiments, if an answering point that is not connected to a packet network is selected, conversion is not necessarily performed.

As well, incoming packet communications can be converted from packet format to circuit based format for circuit based answering points.

FIG. 4B is a flowchart of a method of receiving incoming communications at a data center according to an embodiment of the present invention. Calls from a plurality of communication networks are received. In some embodiments, a plurality of incoming communications is received simultaneously. In the FIG. 4B example, a voice call is received from a PSTN (Step 914), a VoIP call is received from an IP telephony network (Step 916), a wireless telephone call is received from a wireless telephony network (Step 918), an SMS message is received from a IP telephony network (Step 920) and an e-mail message is received from an IP network (Step 922). Each of the received calls is placed in a queue (Step 924) for processing by the data center. In some embodiments, the calls are placed in the queue according to the time when they are received. In other embodiments, the calls are prioritized. The prioritization may be according the location from which the call originated, the network from which the call originated, a priority code, time of arrival of the call, repeat calls within an area, traffic type, call volume or any other characteristic of the call.

FIG. 4C is a flowchart of a method of forwarding a next queue entry to an answering point, wherein the queue contains incoming communications from a plurality of communication networks. An answering point is selected to handle the incoming communication corresponding to the next queue entry (Step 926). The answering point is selected in a manner similar to that described with reference to FIG. 4A. The incoming communication is converted from its original protocol to packet signals compatible for transmission over a packet network (Step 928). If the incoming communication's original protocol is already in packet protocol, Step 928 is not necessary. The packet signals are sent over the packet network to the selected answering point (Step 930).

Step 928 involves converting an incoming communication from one of a plurality of protocols into packet signals, suitable for transmission over a packet network, such as a wide-area IP network. The conversion is dependent on the protocol of the incoming call. For example, the audio from a wireline call received at Step 914 or the wireless call received at Step 918 may be converted from TDM voice to RTP and the inband signalling may be converted to MGCP, MEGACO, SIP or H.323. In another example, SMS may be converted to a call-like representation (i.e. SIP). In still another example, text may be converted to speech. However, the IP voice call received at Step 916 may not need to be converted.

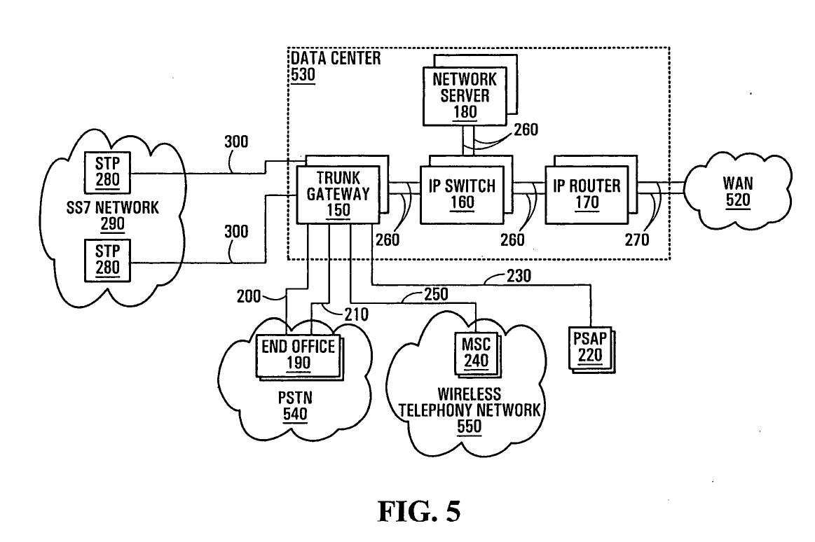

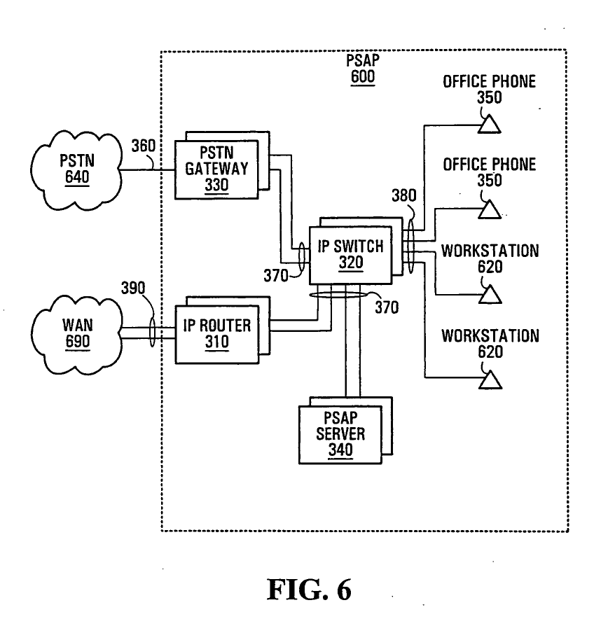

In some embodiments, a workstation at the answering point is also selected to handle the incoming communication. FIG. 4D is a flowchart for a method of directing an incoming communication to a workstation. FIG. 4D starts at point ‘A’ shown on FIG. 4A or point ‘B’ shown in FIG. 4C. First a workstation is selected according to a predetermined selection process (Step 910). Possible methods of selecting a workstation are described below. Then the incoming communication is directed to the selected workstation (Step 912). In some embodiments, the steps of FIG. 4D are performed by a data center, such as the data center described with reference to FIG. 5 below. In other embodiments, they are performed by the selected answering point, such as the answering point described below with reference to FIG. 6.

The determination of which PSAP to select may be based on geographic location of the subscriber device, priority assigned to the subscriber device, the order in which the call is received, the availability of the PSAP or any other characteristic of the incoming communication or PSAP. With reference to the components of FIG. 3, one exemplary method that is used to determine the proper PSAP 110 and individual workstation 120 or 140 according to geographic location of the subscriber device comprises two steps.

The first step is determining the geographical location of the subscriber device and routing the incoming communication to the PSAP responsible for that particular geographic location. The method used to determine the geographic location depends on the network over which the data center receives the incoming communication. One method used is an approximation determined from the physical or virtual circuit on which the incoming communication arrives. This method is known as circuit selective routing. In another method, a location is extracted from a database indexed via the subscriber device address, such as a telephone number. This method is known as address selective routing. In still another method, a location is determined in quasi real-time by position determination equipment deployed in the wireless telephone network 50 or the packet-based IP telephony network 60 and relayed to the data centers 30. This method is known as location selective routing.

The second step is ACD (Automatic Call Distribution), where the appropriate workstation 120 or 140 within a PSAP 110 is selected based on rules. This step is performed at the data center 30 in some embodiments and at the PSAP 110 in other embodiments.

Different methods of ACD can be employed. The ACD can be priority-based, where the incoming communications are assigned to idle workstations 120 or 140 in a preset order. In other embodiments the ACD is circular, where the incoming communications are assigned to idle workstations 120 or 140 in a round-robin fashion. In other embodiments, the ACD is activity-based, where the incoming communications are assigned to the workstation 120 or 140 that has been idle the longest. In still other embodiments the ACD is broadcast, where the incoming communications are presented to all idle workstations 120 or 140 and the first call-taker to answer the call is assigned the call. In still other embodiments, the ACD is based on the longest idle workstation.

The method of determining the proper PSAP 110 and individual workstation 120 or 140 allows management of call flow when multiple communications are simultaneously present within the system. For instance, incoming communications can be diverted to an alternate PSAP 110 when all workstations 120 or 140 within the first selected PSAP are busy. Alternatively, incoming communications can be queued for the first selected PSAP for a preset period of time, after which they can be directed to an alternate PSAP 110. Incoming communications can also be diverted to an alternate PSAP 110 when the number of incoming communications in queue exceeds a certain threshold. The method of determining the proper PSAP 110 and individual workstation 120 or 140 also allows a PSAP 110 to gracefully exclude itself from the normal call distribution rule by activation of a busy condition, either from a mechanical switch or from a software interface, in which case a preset busy rule is invoked to divert the calls to an alternate PSAP 110. The method of determining the proper PSAP 110 and individual workstation 120 or 140 also provides a way to single out and remove duplicate calls within a call queue, if desired.

Data Center Example

FIG. 5 is a block diagram an exemplary data center 530 in accordance with an embodiment of the present invention. In FIG. 5, the data center 530 preferably comprises redundant trunk gateways 150, redundant IP switches 160, redundant IP routers 170, and redundant network servers 180. The trunk gateways 150 connect to end offices 190 in a PSTN 540 via trunks 200 and administrative lines 210, adjacent circuit-based PSAPs 220 via trunks 230, Mobile Switching Centers (MSCs) 240 in the wireless telephone network 550 via trunks 250, and Signal Transfer Points (STPs) 280 within a SS7 network 290 via signaling links 300, such as SS7 “A” links. The IP switches 160 are connected to IP routers 170, trunk gateways 150, and network servers 180 via redundant LAN (Local Area Network) connections 260, such as Ethernet connections. The IP routers 170 are connected to a wide-area network 520 via redundant WAN (Wide Area Network) connections 270, such as ATM or Frame Relay links over copper or optical connections.

When an emergency call arrives at a data center 530 over trunks 200, 230 or 250, it is processed by the trunk gateways 150, where in-band signaling is converted to a packet protocol for processing by the network servers 180. In preferred embodiments the packet protocol is MGCP, MEGACO, SIP or H.323. The audio is also converted for processing by the participants in the call, such as the workstations 120 or 140 in FIG. 3. In a preferred embodiment the audio is converted to RTP. Trunks 200, 230, or 250 can also be used to originate calls into the PSTN 540, the adjacent circuit-based PSAPs 220 or the wireless telephone network 550, respectively, for the purpose of conferencing in or transferring to call-takers on other systems.

The trunk gateways 150 also terminate administrative lines 210 originating from the PSTN 540. These lines can carry incoming and outgoing non-emergency traffic, as well as incoming emergency traffic that was placed by callers using a number other than the designated emergency number (e.g. 911). Administrative lines 210 can also be used to originate calls for the purpose of conferencing in or transferring to entities via the PSTN 540.

The trunk gateways 150 further terminate the SS7 signaling links 300 originating from the STPs 280 in the network 290. These signaling links can carry the signaling for controlling the call setup and tear down over trunks 200, 230, or 250, when in-band signaling is not used.

The IP switches 160 serve as packet switches for the data center 530, by directing all packets coming over the LAN connections 260 from the trunk gateways 150, WAN routers 170, or network servers 180 to the same destinations over the same LAN connections 260. For instance, a trunk gateway 150 could send a MGCP packet to a network server 180, in which case the IP switch would receive the packet on one LAN connection 260 and forward it on another LAN connection 260.

The WAN routers 170 serve to bridge the data center LAN with the wide-area network 520. To this end, they can perform translation from the LAN protocol (e.g. Ethernet) to the WAN protocol (e.g. ATM or Frame Relay), as well as Network Address Translation (NAT) and firewall functions, as appropriate. They can also perform encryption for secure connection of the remote workstations, such as those discussed with reference to FIG. 3, over a public IP network.

The network servers 180 host network call processing and management functions such as the method of determining the proper PSAP, and conferencing in or transferring to other participants as requested by call-takers. The network servers 180 can also maintain system and call statistics for real-time monitoring or statistical analysis.

PSAP Example

FIG. 6 is a block diagram of an exemplary PSAP 600 in accordance with an embodiment of the present invention. In the FIG. 6 example, the PSAP 600 comprises redundant IP routers 310, redundant IP switches 320, redundant PSTN gateways 330, redundant PSAP servers 340, workstations 620, and office phones 350. The PSTN gateways 330 connect to end offices (not shown) in the PSTN 640 via administrative lines 360. The IP switches 320 are connected to the IP routers 310, PSTN gateways 330 and PSAP servers 340 via redundant LAN connections 370. The IP switches 320 are connected to workstations 620 and office phones 350 via LAN connections 380. The IP routers 310 are connected to wide-area network 690 via redundant WAN connections 390 (e.g. ATM or Frame Relay links over copper, optical, or wireless connections).

When a call arrives into the PSAP 600 over the wide-area network 690, it is processed by the PSAP servers 340 to determine the proper workstation to which to present the call. In a preferred embodiment, the PSAP servers 340 work in collaboration with network servers, such as the network servers 180 described with reference to FIG. 5, to determine the proper workstation to which to present the call. The PSAP servers 340 can also perform PSAP call processing and management functions such as conferencing in or transferring to other participants as requested by call-takers. The PSAP servers 340 can also maintain system and call statistics for real-time monitoring or statistical analysis.

As will be recognized by those skilled in the art, the function of PSAP servers 340 may overlap that of network servers 180 described with reference to FIG. 5 to some extent. In the embodiments described with reference to FIGS. 5 and 6, network servers perform functions at the network level and PSAP servers 340 perform functions at the PSAP level. For instance, the method of determining the proper PSAP and workstation may be implemented such that the PSAP is determined by the network servers 180 and the workstation is determined by the PSAP server 340. However, in some embodiments, the function of PSAP servers 340 is totally performed by network servers, in which case PSAP servers 340 are not necessarily present.

The PSTN gateways 330 terminate administrative lines 360 originating from the PSTN 640. These lines can carry incoming and outgoing non-emergency traffic, as well as incoming emergency traffic that was placed by callers using a number other than the designated emergency number (e.g. 911). Administrative lines 360 can also be used to originate calls for the purpose of conferencing in or transferring to entities via the PSTN 640. The PSTN gateways 330 convert calls from the PSTN 640 into packet signals and convert packet signals from the PSAP 600 into audio and signalling for transmission over the PSTN 640.

The IP switches 320 serve as packet switches for the PSAP 110, by directing packets coming over the LAN connections 370 and 380 from the WAN routers 310, PSTN gateways 330, PSAP servers 340, workstations 620, and office phones 350 or to the same destinations over the same LAN connections 370 and 380. For instance, a PSTN gateway 330 could send a MGCP packet to a PSAP server 340, in which case the IP switch 320 would receive the packet on one LAN connection 370 and forward it on another LAN connection 370.

The workstations 620 can be used to answer emergency calls, or they can be used for incoming and outgoing administrative traffic. In either case, the audio from a call-taker can be converted to packets, such as RTP packets, by the workstation 620, and the telephone features can be controlled by the PSAP servers 340. The workstations 620 can also provide emergency call handling features such as the ability to display the caller location in a textual or graphical format; these features are also controlled by PSAP servers 340.

The office phones 350 can be used to answer emergency calls, or they can be used for incoming and outgoing administrative traffic. In either case, the audio from a call taker can be converted to packets, such as RTP packets, by the office phone 350, and the telephone features can be controlled by the PSAP servers 340. The office phones 350 can also provide emergency call handling features such as the ability to display the caller location in a textual format; these features are also controlled by PSAP servers 340.

Systems with Central PSAP

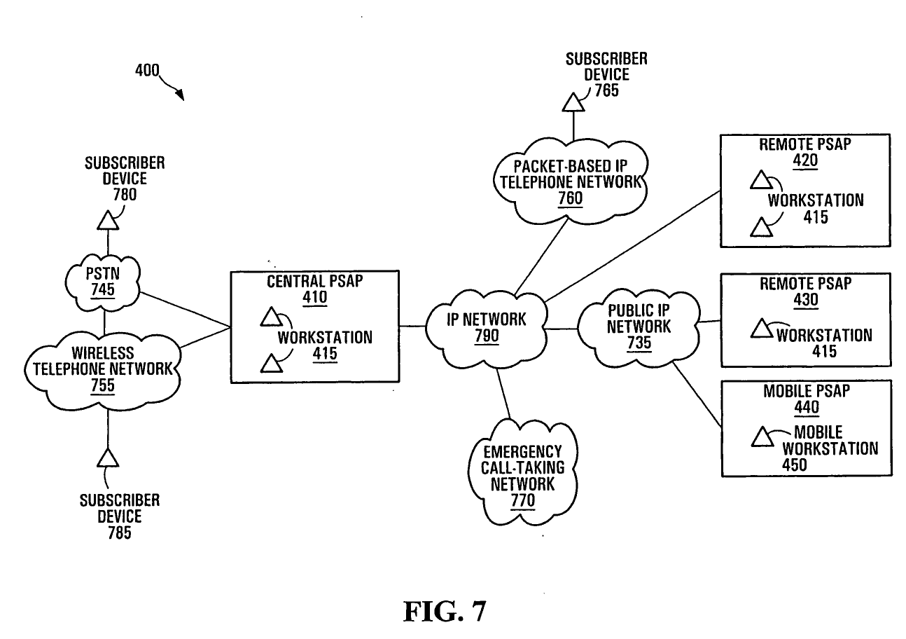

Other embodiments of the system are possible. For instance, a central PSAP can perform the functions of the data centers described above. FIG. 7 is a block diagram of another exemplary call taking system 400 in accordance with an embodiment of the present invention, in which a central PSAP is used. Referring to FIG. 7, a central PSAP 410 is in communication with a wide-area IP network 790, a public switched telephone network (PSTN) 745, a wireless telephone network 755 (e.g. cellular network). The central PSAP 410 is also in communication with a packet-based IP telephone network 760, a remote PSAP 420 and an adjacent emergency call-taking system 770 via the IP network 790. The central PSAP 410 communicates with a remote PSAP 430 and a mobile PSAP 440 via the IP network 790 and a public IP network 735. The two remote PSAPs 420 and 430 comprise call-taker workstations 415, and the mobile PSAP 440 comprises a mobile call-taker workstation 450. Each communication network supports one or more subscriber devices. In the illustrated embodiment, PSTN 745 supports wireline telephony subscriber device 780, wireless telephone network 755 supports wireless telephony subscriber device 785, and packet-based IP telephone network 760 supports IP telephony subscriber device 765. In the example described with reference to FIG. 7, the PSTN 735 and the wireless telephone network 755 are in communication with each other, thus allowing wireless telephony subscribers to call PSTN telephony subscribers and vice versa.

A wireline telephony subscriber device 780 can initiate an emergency call (e.g. 911 call). Such a call is routed through the PSTN 745 to the central PSAP 410, using physical circuits. The PSTN 745 is configured to forward emergency calls to the central PSAP 410. The central PSAP 410 determines the proper PSAP 410, 420, 430 or 440 and individual workstation 415 or 450 to which to present the call. Such determination may be based on the geographical location of the subscriber device 780 obtained from the PSTN 745, using the method described in detail earlier. The workstation 415 or 450 can then be used to answer the call, which has been converted to IP packets and, if one of the remote PSAPs 420, 430 or mobile PSAP 440 is selected, sent over the IP network 790. Subsequently, the call can be transferred to any other workstation 415 or 450, any wireline telephony subscriber device 780 via the PSTN 745, any wireless telephony subscriber device 796 via the PSTN 745 and the wireless telephone network 755 or directly via the wireless telephone network 755, or any IP telephony subscriber device 765 via the packet-based IP telephony network 760.

A wireless telephony subscriber device 785 can initiate an emergency call (e.g. 911 call). Such a call is routed through the wireless telephone network 755 to the central PSAP 410, using physical circuits. The wireless telephone network 755 is configured to forward emergency calls to the central PSAP 410. The central PSAP 410 determines the proper PSAP 410, 420, 430 or 440 and individual workstation 415 or 450 to which to present the call. Such determination may be based on an approximation of the geographical location of the subscriber device 780 obtained from the wireless telephone network 755, using a method described in detail earlier. The workstation 415 or 450 can then be used to answer the call, which has been converted to IP packets and, if one of the remote PSAPs 420, 430 or mobile PSAP 440 is selected, sent over the IP network 790. Subsequently, the call can be transferred to any other workstation 415 or 450, any wireline telephony subscriber device 780 via the PSTN 745, any wireless telephony subscriber device 785 via the PSTN 745 and the wireless telephone network 755 or directly via the wireless telephone network 755, or any IP telephony subscriber device 765 via the IP telephony network 760.

An IP telephony subscriber device 765 can initiate an emergency call (e.g. 911 call). Such a call is routed through the IP telephone network 760 to the central PSAP 410, using virtual circuits established via the IP network 790. The IP telephone network 760 is configured to forward emergency calls to the central PSAP 410. The central PSAP 410 determines the proper PSAP 410, 420, 430 or 440 and individual workstation 415 or 450 to which to present the call. Such determination is based on an approximation of the geographical location of the subscriber device 765 obtained from the IP telephone network 760, using a method described in detail earlier. The workstation 415 or 450 can then be used to answer the call, which is sent over the IP network 790 as IP packets if one of the remote PSAPs 420, 430 or mobile PSAP 440 is selected. Subsequently, the call can be transferred to any other workstation 415 or 450, any wireline telephony subscriber device 780 via the PSTN 745, any wireless telephony subscriber device 785 via the PSTN 745 and the wireless telephone network 755 or directly via the wireless telephone network 755, or any IP telephony subscriber device 765 via the IP telephony network 760.

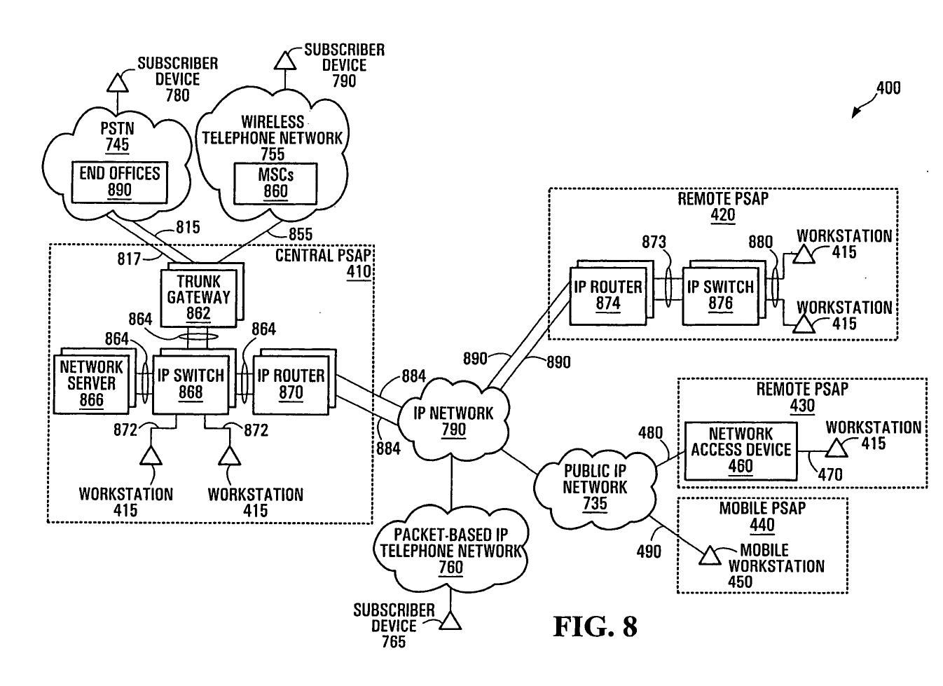

FIG. 8 is a block diagram showing the components of embodiments of the PSAPs in a system having a central PSAP. Central PSAP 410 comprises redundant trunk gateways 862, redundant IP switches 868, redundant IP routers 870, redundant network servers 866, and workstations 415. The trunk gateway 862 connects to end offices 890 in PSTN 745 via trunks 817 and administrative lines 815, and to Mobile Switching Centers (MSCs) 860 in the wireless telephone network 755 via trunks 855. The IP switches 868 are connected to the trunk gateways 862, IP routers 870 and network servers 866 via redundant LAN connections 864 (e.g. Ethernet connections). The IP switches 868 and workstations 415 are interconnected via LAN connections 872 (e.g. Ethernet connections). The IP routers 870 are connected to the wide-area IP network 790 via redundant WAN connections 884 (e.g. ATM or Frame Relay links over copper or optical connections).

Remote PSAP 420 comprises redundant IP routers 874, redundant IP switches 876, and workstations 415. The IP routers 874 and IP switches 876 are interconnected via redundant LAN connections 873. The IP switches 876 and workstations 415 are interconnected via LAN connections 880. The IP routers 874 are connected to the wide-area IP network 790 via redundant WAN connections 890.

Remote PSAP 430 comprises network access device 460 (e.g. a DSL modem or cable modem) and workstation 415. Network access device 460 and workstation 415 are interconnected via LAN connection 470. The network access device 460 is connected to the wide-area network 790 via WAN connection 480 (e.g. a DSL or cable connection), using a virtual network tunneled via the public IP network 735.

Remote PSAP 440 comprises mobile workstation 450 (e.g. a laptop computer) comprising an integrated network access device (e.g. dial-up modem, or wireless network interface). The mobile workstation 450 is connected to the wide area network 790 via WAN connection 490 (e.g. a dial-up connection over a telephone line, or a wireless connection), using a virtual network tunneled via the public IP network 735.

When an emergency call arrives into the central PSAP 410 over trunks 817 or 855, it is processed by the trunk gateways 862, where the in-band signaling is converted to packet protocol, such as MGCP, MEGACO, SIP or H.323 for processing by the network servers 866, and the audio is converted to packet protocol, such as RTP, for processing by the participants in the call (e.g. the workstations 415 or 450).

Trunks 817 or 855 can also be used to originate calls into the PSTN 745 or wireless telephone network 755 for the purpose of conferencing in or transferring to call-takers on other systems. The trunk gateways 862 can also terminate administrative lines 815 originating from the PSTN 745. These lines can carry incoming and outgoing non-emergency traffic, as well as incoming emergency traffic that was placed by callers using a number other than the designated emergency number (e.g. 911). Administrative lines 815 can also be used to originate calls for the purpose of conferencing in or transferring to entities via the PSTN 745.

The IP switches 868 serve as packet switches for the central PSAP 410, by directing packets coming over the LAN connections 864 and 872 from the trunk gateways 862, IP routers 870, network servers 866, and workstations 415 to the same destinations over the same LAN connections 864 and 872. For instance, a trunk gateway 862 could send a MGCP packet to a network server 866, in which case the IP switch 868 would receive the packet on one LAN connection 864 and forward it on another LAN connection 864.

The IP routers 870 serve to bridge the central PSAP LAN with the wide-area IP network 790. To this end, they can perform translation from the LAN protocol (e.g. Ethernet) to the WAN protocol (e.g. ATM or Frame Relay), as well as Network Address Translation (NAT) and firewall functions, as appropriate. They also can perform encryption for secure connection of the remote PSAPs 430 and 440 over the public IP network 735.

The network servers 866 host the network call processing and management functions such as the method of determining the proper PSAP, and the conferencing in or transferring to other participants as requested by the call-takers. The network servers 866 can also maintain system and call statistics for real-time monitoring or statistical analysis. In this particular example, the network servers 866 perform the combined function of PSAP servers described with reference to FIG. 6, as discussed earlier.

The IP switches 876 serve as packet switches for the PSAP 420, by directing packets coming over the LAN connections 873 and 880 from the IP routers 874 and workstations 415, respectively, to the same destinations over the same LAN connections 370 and 380. For instance, an IP router 874 could send a MGCP packet to a workstation 415, in which case the IP switch would receive the packet on one LAN connection 873 and forward it on another LAN connection 880. The network access device 460 serves to bridge the workstation 415 in remote PSAP 430 with the wide-area network 790. To this end, it performs translation from the workstation protocol (e.g. Ethernet) to the WAN protocol (e.g. DSL or cable).

For remote PSAP 430, as well as for mobile PSAP 440 case, the Network Address Translation (NAT) and firewall functions are performed by the workstation 415 or 450, respectively. The workstations 415 or 450 can be used to answer emergency calls, or they can be used for incoming and outgoing administrative traffic. In either case, the audio is converted to packets, such as RTP packets, by the workstation 415 or 450, and the telephone features are controlled by the network servers 866 in the central PSAP 410. The workstations 415 or 450 can also provide emergency call handling features such as the ability to display the caller location in a textual or graphical format; these features are also controlled by network servers 866.

Audio Management

Preferably, workstations at answering points communicating over a packet network can manage the audio going to an operator's headset such that only one headset is required to listen to the audio from the caller and to perform radio dispatch function over a radio network.

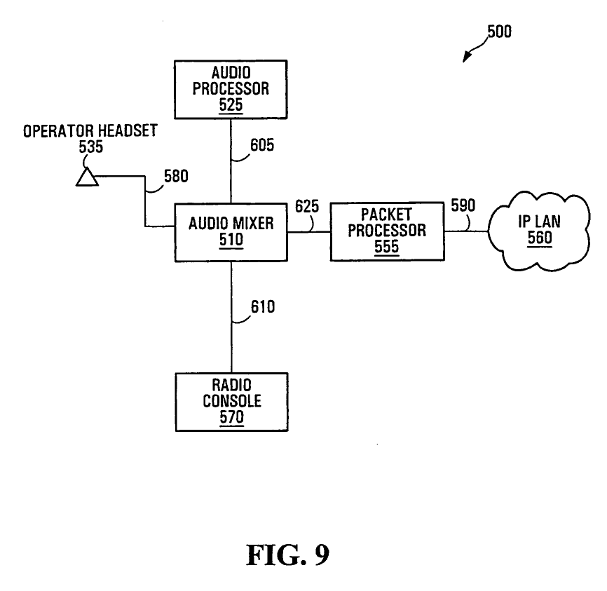

FIG. 9 is a block diagram of an audio management module 500 to be used by a call-taker within an answering point. Referring to FIG. 9, the audio management module 500 comprises an audio mixer 510, an audio processor 525, an operator headset 535, a packet processor 555, IP LAN 560 and a radio console 570. In some embodiments a supervisor headset is also present. In some embodiments the supervisor headset is the same as the operator headset.

Interface 580 connects the headset 535 to the audio mixer 510. A packet interface 590 connects the packet processor 555 to the IP LAN 560. An interface 605 connects the audio processor 525 to the audio mixer 510. An interface 615 connects the radio console 570 to the audio mixer 510. An interface 625 connects the audio mixer 510 to the packet processor 555.

The audio mixer 510 permits replication or summation of any combination of input ports (not shown) to any output port (not shown), with preset gain. The input and output ports may be in communication with any type of audio device, such as the operator headset 535, a workstation, a radio console, or a telephone. For example, in some embodiments, the audio mixer 510 allows the audio from headset 535 to be sent back to headset 535 at a lower level, such as a sidetone, to packet processor 555 for converting to RTP, and to radio console 570.

The audio processor 525 provides functions such as tone generation, tone decoding, or implementation of baseband modems. For instance, in some embodiments, the audio processor 520 can implement a FSK modem for implementing a TTY functionality.

The headset 535 provides the audio for the emergency and administrative telephone calls handled by the workstation.

The packet processor 555 provides the functionality of converting between audio streams and RTP packets.

The audio management module 500 can be implemented in hardware, software or a combination thereof. For example, one embodiment of audio management module 500 implements audio mixer 510 and audio processor 525 as software running on a dedicated expansion card (e.g. PCI card), interface 580 as a baseband analog audio interface, interface 605 as a software interface, interface 615 as a baseband audio interface with digital control signals, packet processor 555 as a process on the workstation central processor, interface 625 as an expansion card interface (e.g. PCI interface), and packet interface 590 as the workstation network interface.

Another embodiment of audio management module 500 implements audio mixer 510, audio processor 525 and packet processor 555 as processes on a workstation central processor, headset 535 as a digital headset, interface 580 as a USB interface, interface 610 as the workstation baseband audio interface (e.g. line in/out), interfaces 605 and 625 as software interfaces, and packet interface 590 as the workstation interface. As those skilled in the art recognize, other embodiments of audio management module 500 are possible. Embodiments of the present invention do not depend on a specific embodiment of the audio processor.

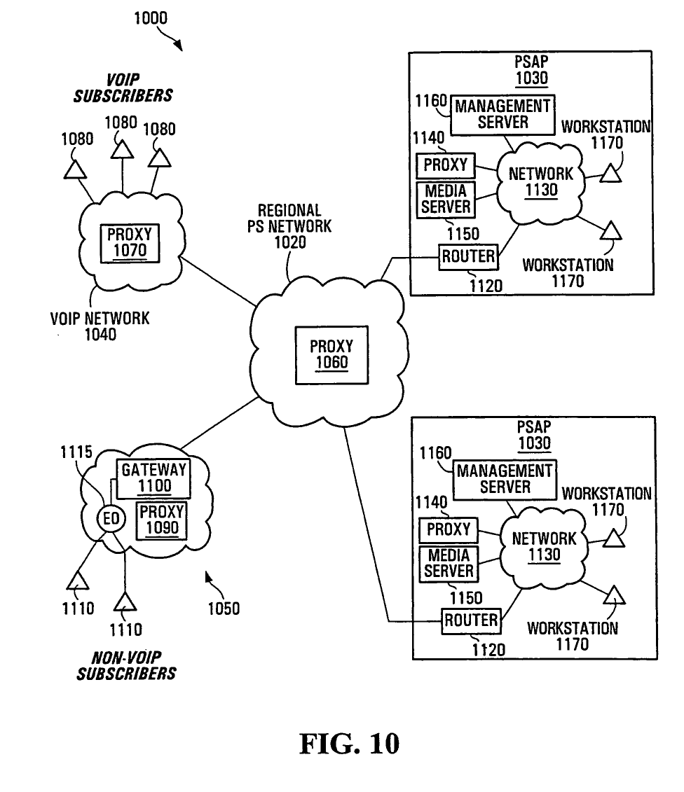

Referring now to FIG. 10, shown is a system diagram of another call-taking system, generally indicated by 1000. With the embodiment of FIG. 10, the routing of calls is achieved through a series of proxies rather than in any one single central facility. The particular example shown features a regional public safety network 1020 to which are connected a plurality of PSAPs 1030, two shown in the illustrated embodiment. Also connected to the regional public safety network 1020 are any other networks to which call-taking services are to be provided. In the particular example shown, this consists of a voice over IP network 1040 and a legacy circuit switched voice network 1050. However, it is to be understood that other networks can also be connected to a regional public safety network 1020 in a similar manner. These might include for example wireless networks.

Specific details of the VoIP network 1040 are shown, these consisting of three VoIP subscribers 1080 and a proxy server 1070. More generally, the VoIP network may take any number of forms with any number of subscribers.

For the legacy network 1050, shown are two legacy terminals 1110 connected to a legacy end office 1115. The legacy end office 1115 is in turn connected to an IP gateway 1100. There is also a proxy server 1090. The particular manner in which the components of the legacy network 1050 are connected is to be considered one particular example. Of course any number of legacy terminals 1110 can be supported. Important features include the voice over IP gateway 1100 and the proxy server 1090.

The regional public safety network 1020 also has a proxy server 1060. The public safety network is preferably a wide area IP network, but other types of packet networks may alternatively be employed in which case VoIP gateways would be replaced with appropriate packet network gateways.

The two PSAPs 1030 are shown to be identically configured. However, it is to be understood that the actual layout and configuration of two or more PSAPs can be different. In the illustrated example, each PSAP consists of a router 1120 connected to a data network 1130. A plurality of PSAP workstations 1170 are connected to the network. Also shown is a proxy server 1140. Preferably, a management server 1160 and a media server 1150 are also provided. The Management server 1160 is used for provisioning and statistical reporting. The media server 1150 provides services such as recorded messages and interactive voice response (IVR).

In order to set up a call, a hierarchy of proxies are involved. For example, for a call set up request from a voice over IP subscriber 1080 through to a workstation in PSAP 1030, proxy servers 1070, 1060 and 1140 would be involved. The same hierarchy approach is used for any network connected to the regional public safety network 1020. Particular examples will now be described.

In the FIG. 10 system, a VoIP telephony subscriber 1080 can initiate an emergency call (e.g. 911 call). A call set up request is sent from the subscriber 1080 to the proxy server 1070. The IP address of the proxy server 1070 is provisioned in the subscriber 1080 terminal, either statically or dynamically through DHCP.

The proxy server 1070, based on a registration method to be discussed later, knows that the proxy server 1060 is responsible for the call, based on the location information contained in the call set up request. The proxy server 1070 therefore forwards the call set up request to proxy server 1060. In this scenario, proxy server 1060 is the highest level server. For example, in some embodiments, proxy server 1060 is a TLD (Top Level Domain) sos.arpa server and proxy server 1070 is part of a telephone company network and is for example, proxy 1234.bell.ca.

In turn proxy server 1060 knows which proxy server 1140 is responsible for the call set up request based on location information contained in the call set up request. The proxy server 1060 forwards the call set up request to the appropriate proxy server 1140.

The proxy server 1140, preferably based on information contained in the corresponding management server 1160, determines which workstation(s) 1170 to which to forward the call set up request. The proxy server 1140 therefore forwards the call set up request to the appropriate workstations 1170. At this point, the workstations 1170 ring and the caller location information is displayed on the workstations.

Once an operator answers, the call path is established. In some embodiments, the signalling, such as SIP, for the call always goes through the proxy servers 1070, 1060, 1140, for the purpose of tracking the end of the call for statistical purposes.

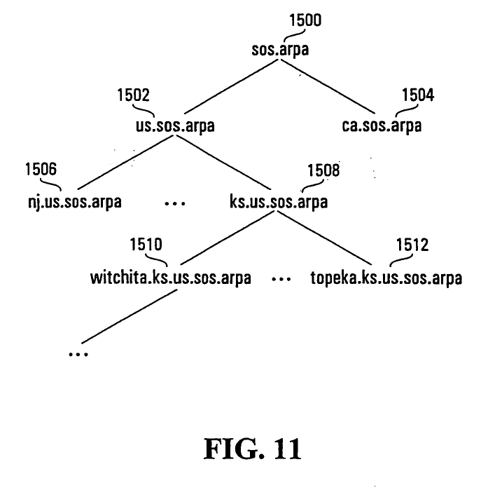

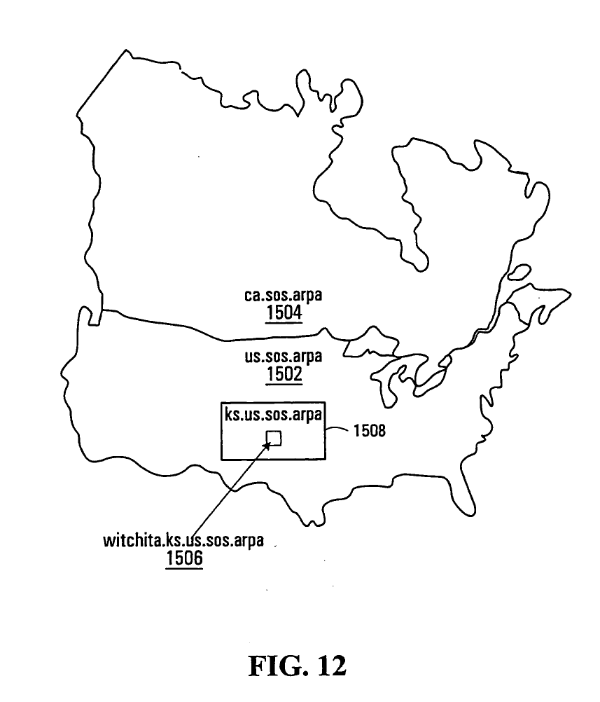

FIG. 10 shows only one proxy server 1060 in the network 1020, but in some implementations there may be multiple proxies, forming a hierarchy. An example of this is shown in FIG. 11. The top-level proxies 1500 responsible for a top level domain such as the sos.arpa domain, i.e. the proxies responsible for whole-earth emergency call routing would be reached by sip:sos@sos.arpa. In turn, these proxies may have national proxies such as us.sos.arpa 1502 and ca.sos.arpa 1504 registered with them, that may themselves have state-wide proxies such as ny.us.sos.arpa 1506 and ks.us.sos.arpa 1508 registered with them, which may themselves have individual PSAP proxies such as wichita.ks.us.sos.arpa 1510 and topeka.ks.us.sos.arpa 1512 registered to them. The only piece of information the intermediate proxies need to be provisioned with is what the upper-level proxy server is. The only piece of information the lowest-level proxy server (wichita.ks.us.sos.arpa in this example) feeds to the upper-level proxy server is the geographic coverage of the proxy server, that might for example be expressed in the form of a polygon; in turn, the information is propagated up to the upper-layer-proxies that resolve the polygons into larger polygons representing their aggregate coverage. An example of this is shown in FIG. 12 where the polygon for ca.sos.arpa is indicated at 1520; the polygon for us.sos.arpa is indicated at 1522; the polygon for domain ks.us.sos.arpa is indicated at 1524; and the polygon for wichita.ks.us.sos.arpa is indicated at 1526. Optionally, any proxy server may validate the registrations of lower-level proxies; for example, us.sos.arpa may validate that all registration requests indeed specify polygons that fall within the United States. Optionally, any proxy server may override the registrations of lower-level proxies; for example, ks.us.sos.arpa may have the territory covered by the lower-level proxies configured in a static database rather than relying on the registration information received from the lower-level proxies. The polygons can be defined using any appropriate mechanism. For example, they can be defined by a set of connected x, y coordinates. Preferably, the location information contained in the call is easily mapped to the polygon definitions.

When sending an emergency call, the only piece of information an IP telephone needs to know is its location. It then sends an invite message to sip:sos@sos.arpa, with the location contained in the message. There are well known mechanisms for IP telephones to acquire their location. Preferably, the location information consists of X, Y geographical coordinates, such as provided for in IETF RFC 3825.

More generally, an agent of the end user device needs to be able to determine the end user device's location. For example, for the legacy users in FIG. 10, the gateway 1100 and/or the proxy server 1090 can determine the location of the legacy subscriber terminal 1110 that initiated the call and include this location in the call set up request. Then, the hierarchy of proxy servers such as that illustrated in FIG. 11 is implemented within the regional public safety network.

In this embodiment, proxy server 1070 is used for non-911 calls and for forwarding 911 calls to proxy server 1060.

The call set up request might for example be a SIP invite. Upon receiving a call set up request, the sos.arpa proxy server verifies which lower level proxy server registered the polygon containing the location that the call originated from, and redirects the invite message to that proxy server. The process continues until the proxy server responsible for the individual PSAP is reached; this proxy server then selects a call-taking position to present the call to, according to rules that are local to that proxy server.

As discussed above, this system is not limited to routing VoIP calls. When a legacy (non-VoIP) subscriber dials the designated emergency number (e.g. “911”), the legacy telephone network 1050 routes the call, using standard methods, up to a gateway 1100. In turn, gateway 1100 sends a call set up request to a proxy server 1090, that is responsible for inserting the location information in the message and redirecting the message to sos.arpa. The remainder of the process is identical to that described for the VoIP terminal.

In some implementations, some terminals may not be aware of their location. For instance, within a campus network, individual terminals may not implement the established means of acquiring and sending their location information discussed earlier. In such cases, calls dialed to the designated emergency address (e.g. “sip:sos@example.com”) may be redirected to a proxy server 1070, responsible for determining the location of the calling terminal (for instance by looking it up in a static database) and inserting it in the message prior to redirecting the invite to sos.arpa.

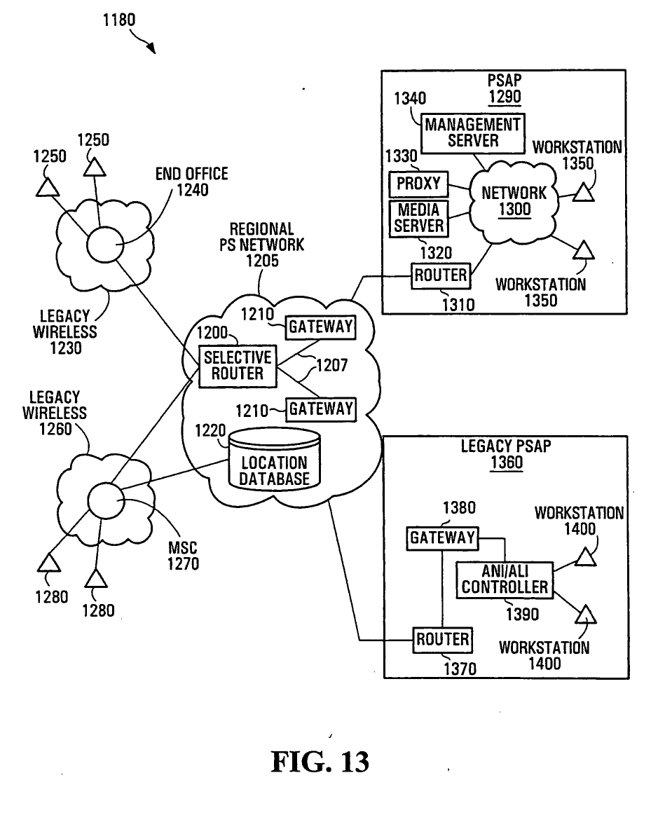

It is possible that in migrating towards a system such as that of FIG. 10, a bottom-up approach will be adopted in which proxy servers are first introduced in the PSAP, and then introduced in stages higher and higher through the network. An example of this is shown in FIG. 13 where depicted is an interim implementation of the FIG. 10 embodiment in which there is only the lowest-level proxy existing that is deployed within an individual PSAP. With the example of FIG. 13, there is a regional public safety network 1205 that connects a legacy wireline network 1230 and a legacy wireless network 1260 to PSAPs 1290 and 1360 of which PSAP 1360 is a legacy PSAP. It should be understood that additional networks can be connected to the regional public safety network 1190 and that additional PSAPs may be provisioned as required.

The legacy wireline network 1230 consists of legacy terminals 1250 connected to an end office 1240. The legacy wireless network 1260 consists of a set of legacy wireless terminals 1280 connected via an access network (not shown) and ultimately to a mobile switching centre 1270. PSAP 1290 is substantially the same as the PSAPs 1030 of FIG. 10, this consisting of a PSAP router 1310, PSAP network 1300, PSAP workstations 1350, management server 1340, PSAP proxy server 1330 and PSAP media server 1320.

The legacy PSAP 1360 is shown to consist of legacy equipment consisting of legacy PSAP workstations 1400 and an ANI/ALI controller 1390. This is connected to a legacy PSAP gateway 1380 and legacy PSAP router 1370. Of course, the particular configuration and layout of the PSAPs 1180, 1360 can be other than that specifically shown.

The regional public safety network 1205 has a selective router 1200 connected to one or more gateways 1210 by respective trunk groups 1207. The selective router 1200 performs circuit switching to switch a received legacy call out on one of the trunks 1207 to one of the gateways 1210. Also shown as part of the regional public safety network 1205 is a location database 1220.

In operation, the selective router 1200 is responsible for selecting the proper PSAP to which to send the call, usually based on the origin number of the call. Depending on which PSAP is chosen, the selective router 1200 will pick a different trunk group 1207 to which to send the call. In turn, the call reaches a gateway 1210, where conversion from circuit-switched technology to VoIP is performed. Assuming the call is to be handled by a non-legacy PSAP (such as PSAP 1290), the gateway 1210 inserts an address (for example a SIP address) of the destination PSAP proxy server 1330 in the call set up request. The message includes the origin number of the caller.

The proxy server 1330 selects which workstation 1350 will be presented the call. The order in which calls are assigned is preferably configurable, and can be based on priority, on longest idle workstation, or alternatively multiple workstations can ring simultaneously. The proxy server 1330 also retrieves the caller location. This may, for example, be performed by indexing the ALI database 1220 with the origin number. The location information is added to the message sent to the assigned workstation.

In the event the call is to be handled by a legacy PSAP, such as a legacy PSAP 1360, the gateway 1380 is responsible for converting the call set up request back into a circuit-switched call routed to the legacy controller 1390, which will in turn direct the call to one or more of the workstations 1400. The legacy controller 1390 may index the ALI database 1220 for presenting the location information to the workstations.

Whereas the system of FIG. 10 was described as using geographic location in the form of points and polygons, the system of FIG. 13 may, for example, use civic location in the form of street name and address for wireline calls, supplemented with the longitude and latitude of the caller for wireless information. Such systems can alternatively employ geographic location systems as discussed above.

In a further evolution of the example of FIG. 13 that brings it closer to the FIG. 10 embodiment, the selective router 1190 is migrated into a proxy server with a function identical to proxy server 1060 in FIG. 10.

What has been described is merely illustrative of the application of the principles of the invention. Other arrangements and methods can be implemented by those skilled in the art without departing from the spirit and scope of the present invention.

1. A call taking system for providing call taking service for a plurality of communication networks, the call taking system comprising:
a packet network;
a plurality of answering points; and
at least one data center configured to: a) receive incoming communications from the plurality of communication networks; and b) for each incoming communication, select an answering point from the plurality of answering points to handle the incoming communication and send the incoming communication to the answering point selected via the packet network.

2. The call taking system of claim 1, wherein the voice communications comprise at least one of circuit switched voice calls and Voice Over IP voice calls, and the non-voice calls comprise at least one of email, SMS (Short Message Service) communications, telematics and Instant Messaging.

3. The call taking system of claim 1, wherein the data center handles the incoming communications collectively according to order of arrival.

4. The call taking system of claim 1, wherein the data center handles the incoming communications collectively according to priority.

5. The call taking system of claim 1, wherein the data center handles the incoming communications so as to perform load balancing of the incoming communications at the plurality of answering points.

6. The call taking system of claim 1, wherein the data center is also configured to convert the at least any incoming communications not already in packetized format from a communication network protocol to a packet protocol suitable for transmission over the packet network.

7. The call taking system of claim 1, wherein the data center is also configured to convert packet signals received over the packet network into a communication network protocol signal suitable for transmission over one of the plurality of communication networks and to send the network protocol signal over the communication network.

8. The call taking system of claim 1, wherein the communication networks are selected from the group consisting of: a PSTN (Public Switched Telephone Network); a wireless telephone network; a SS7 network; an IP telephony network, and an adjacent call taking system.

9. The call taking system of claim 1, wherein the answering points are PSAPs (Public Safety Answering Points).

10. The call taking system of claim 1, further comprising:
at least one central answering point comprising the at least one data center, wherein for each incoming communication, if the at least one central answering point is selected to handle the incoming communication, the incoming communication is sent directly to the at least one central answering point.

11. The call taking system of claim 1, wherein the answering points each comprise a server and at least one workstation.

12. The call taking system of claim 1, wherein at least one answering point comprises a radio console, an operator headset, a packet interface and an audio management module configured to replicate audio from at least the radio console, the operator headset and the packet interface.

13. The call taking system of claim 12, wherein the at least one answering point further comprises a workstation and a telephone, and the audio management module also replicates audio from the workstation and the telephone.

14. The call taking system of claim 1, wherein the data center comprises:
a gateway for interfacing with the communication networks, the gateway configured to receive the incoming communications and to convert non-packet incoming communications to packet signals;
a packet interface for interfacing with the packet network, the packet interface configured to send and receive packet signals to and from the plurality of answering points via the packet network; and
a server configured in such a manner that for each incoming communication the server: selects one of the plurality of answering points to handle the incoming communication; and instructs the packet interface to send the incoming communication to the answering point selected.

15. The call taking system of claim 13, wherein the gateway is also configured to convert packet signals received over the packet network into a communication network protocol signal suitable for transmission over one of the plurality of communication networks and to send the network protocol signal over the communication network.

16. A data center for routing communications from a plurality of communication networks to a plurality on answering points, the data center comprising: a gateway for interfacing with the communication networks, the gateway configured to receive incoming communications and to convert non-packet incoming communications to packet signals;
a packet interface for interfacing with a packet network, the packet interface configured to send and receive packet signals to and from a plurality of answering points via the packet network; and
a server configured in such a manner that for each incoming communication the server: selects one of the plurality of answering points to handle the incoming communication; and instructs the packet interface to send the incoming communication to the answering point selected.

17. The data center of claim 16, wherein the gateway is also configured to convert packet signals received over the packet network into a communication network protocol signal suitable for transmission over one of the plurality of communication networks and to send the network protocol signal over the communication network.

18. The data center of claim 16, wherein the server is also configured to select a workstation within the answering point to handle the incoming communication.

19. The data center of claim 16, wherein the gateway also interfaces directly with at least one answering point.

20. The data center of claim 16, wherein the server handles incoming communications collectively according to order of arrival.

21. The data center of claim 16, wherein the server handles incoming communications collectively according to priority.

22. The data center of claim 16, wherein the server handles incoming calls collectively so as to perform load balancing of the incoming communications at the answering points.

23. A method of routing communications from a plurality of communication networks to one of a plurality of answering points, the method comprising:
receiving an incoming communication from any one of the communication networks;
selecting one of the answering points to handle the incoming communication;
sending the incoming communication to the answering point selected via a packet network.

24. The method of claim 23, further comprising converting the incoming communication into IP packets before sending the incoming communication to the answering point.

25. The method of claim 23, further comprising:
selecting a workstation within the answering point to receive the incoming communication; and
sending the incoming communication to the workstation.

26. The method of claim 23, wherein the selecting the answering point is based on an approximate geographic location of a subscriber device that initiated the incoming communication.

27. The method of claim 23, wherein the approximate geographic location of the subscriber device is determined using a method selected from the list consisting of: circuit selective routing, address selective routing, and location selective routing.

28. The method of claim 25, wherein the selecting the workstation is done a method selected from the list consisting of: priority-based ACD (Automated Call Distribution), round-robin ACD, broadcast ACD and longest idle ACD.

29. The method of claim 23, further comprising:
tracking the order of arrival of each incoming communication.

30. The method of claim 23, further comprising prioritizing the incoming communication.

31. The method of claim 23, further comprising prioritizing the incoming communication so as to perform load balancing of the incoming communications at the answering points.

32. The method of claim 31, wherein the prioritizing is based on a method selected from the group consisting of: time of receipt, location of device that originated the call, a characteristic associated with the device that originated the incoming communication, the communication network from which the incoming communication originated, dealing with multiple calls from a same caller as one call wherein priority of a first call from the same caller is considered, and giving repeat calls from a same geographic location a lesser priority.

33. The method of claim 23 wherein the incoming communication is selected from the group consisting of: a PSTN (Public Switched Telecommunication Network) call, an IP telephony call, a wireless telephony call, an e-mail message, a SMS (Short Message Service) message, a telematics communication, and an Instant Messaging communication.

34. The method of claim 23, wherein if the answering point selected is in direct communication with a data center, the incoming call is sent directly to the answering point selected.

35. A call-taking system for providing emergency call taking for a plurality of communications networks, the system comprising:
a plurality of PSAP call centres;
a packet network interconnecting the plurality of communications networks and the plurality of PSAP call centres, the packet network comprising at least one packet network proxy server;
each PSAP call centre comprising a PSAP call center network, a plurality of PSAP workstations and a PSAP proxy server;
wherein each call setup request received by the packet network proxy server from one of the communications networks contains location information;
wherein for each call set up request the packet network proxy server uses the location information to select a PSAP call centre of the plurality of PSAP call centres and forwards the call setup request to the PSAP proxy server of the selected PSAP call centre;
wherein each PSAP proxy server is responsible for selecting a particular one of the PSAP workstations to handle each call setup request received by the PSAP proxy server;
wherein after selection of the particular PSAP workstation to handle the call setup request, a connection is established from between a calling device or an agent of the calling device to the selected PSAP call center via the network.

36. The system of claim 35 wherein the location information comprises geographic X, Y coordinates.

37. The system of claim 35 wherein the packet network comprises a hierarchy of proxy servers that collectively provide call routing for a hierarchy of geographical regions, each proxy server in the hierarchy resolving location information to a particular proxy server below in the hierarchy.

38. The system of claim 35 further comprising:
a respective proxy server provided in at least one of said communications networks, the proxy server determining the location information to be associated with calls that do not have location information already associated with them, and the proxy server routing each call to the proxy server of the packet network.

39. The system of claim 38 wherein the communications networks comprise at least one voice over IP network and one legacy circuit switched network, the system further comprising for each legacy circuit switched network:
a gateway from the legacy circuit switched network to the packet network, the gateway acting as an agent for legacy terminals for the purpose of VoIP connections and call setup;
a proxy server for determining location information for the legacy calls.

40. The system of claim 35 wherein each PSAP call center performs call distribution taking into account local factors.

41. A call-taking system for providing emergency call taking for a plurality of communications networks, the system comprising:
a plurality of PSAP call centres;
a wide area packet network having circuit switched connections to the plurality of communications networks and connected to the plurality of PSAP call centres, the packet network comprising a selective router and at least one VoIP gateway;
at least one VoIP PSAP call centre comprising a PSAP call center packet network, a plurality of PSAP workstations and a PSAP proxy server;
wherein each call received at the selective router from one of the communications network contains an Emergency Services Routing Key (ESRK), or in the case of a wireline call, ANI (Automatic Number Identification);
the selective router uses the ESRK or ANI to select a VoIP gateway to handle each call, the selected VoIP gateway sending a call setup request to a proxy server in a PSAP call centre;
wherein each PSAP proxy server is responsible for selecting a particular one of the PSAP workstations to handle each call setup request received by the PSAP proxy server;
wherein after selection of the particular PSAP workstation to handle the call set up request, a VoIP connection is established from between the gateway and the selected PSAP call centre via the network.

42. The system of claim 41 further comprising:
at least one legacy PSAP call centre comprising a VoIP gateway for converting from VoIP to circuit switched connections, the legacy PSAP call centre further comprising a plurality of PSAP workstations;
a telephone system with ACD functions for receiving an incoming call and selecting a particular PSAP workstation to handle the call.

43. The system of claim 41 further comprising:
a location database;
wherein location inquiries are sent from the VoIP PSAP call centres to the location data base after a call setup request has been routed to the proxy server of the PSAP call centre.

44. The system of claim 42 further comprising:
a location database;
wherein location inquiries are sent from the legacy PSAP call centres to the location data base after a call setup request has been routed to the proxy server of the PSAP call centre.

45. The system of claim 41 wherein the location information is selected from the group consisting of a civic address and X, Y coordinates.

46. The system of claim 41 wherein each PSAP call centre performs call distribution taking into account local factors.
